(19) United States
(12) Patent Application Publication
(10) Pub. No.: US 2011/0304708 A1
(43) Pub. Date: Dec. 15, 2011

(54) SYSTEM AND METHOD OF GENERATING STEREO-VIEW AND MULTI-VIEW IMAGES FOR RENDERING PERCEPTION OF DEPTH OF STEREOSCOPIC IMAGE

(75) Inventor: Artyom Konstantinovich IGNATOV, Khabarovsk (RU)

(73) Assignee: SAMSUNG ELECTRONICS CO., LTD., Suwon-si (KR)

(21) Appl. No.: 13/105,938

(22) Filed: May 12, 2011

(30) Foreign Application Priority Data
Jun. 10, 2010 (RU) 2010123652

(51) Int. Cl. H04N 13/04

(52) U.S. Cl. 348/51; 348/E13.026

(57) ABSTRACT

Methods and apparatuses for stereo-view visualization for control of perception of depth of a stereoscopic image generated by display device are provided. The method of stereo-view visualization for control of perception of depth of a stereoscopic image generated by display device, includes: estimating a disparity map for a source stereo-view image; adjusting depth perception parameters adjustment of depth perception of observed 3D content in TV-set; generating a modified stereo-view image based on the source stereo-view image, the adjusted depth perception parameters and the estimated disparity map; and post-processing the modified stereo-view image by spatial filtering of disocclusions of the modified stereo-view image.

### CROSS-REFERENCE TO RELATED PATENT APPLICATIONS

This application claims priority from Russian Patent Application No. 2010123652, filed on Jun. 10, 2010, the disclosure of which is incorporated herein in its entirety by reference.

### BACKGROUND

1. Field

Systems and methods consistent with exemplary embodiments relate to processing images of stereo and video data, and, in particular, to stereo-view and multi-view visualization (rendering) for control of perception of depth of a stereoscopic image in a three-dimensional (3D) television (TV).

2. Description of the Related Art

3D TV is expected to be the next generation of TV technology which surpasses traditional TV technology by offering to an observer not only sequences of 2D images but streams of 3D scene representations. A desired functionality for a 3D TV device is the possibility to change depth of a displayed stereoscopic image for individual user preferences. The task of new views synthesis should be solved for depth control functionality. New virtual views are synthesized using information from a disparity/depth map that should be calculated from an input stereo pair of images. View visualization requires correct disparity values per pixel because the quality of synthesized views strongly depends on the quality of the depth map.

A disparity estimation method, also known as a stereo matching method, determines point-to-point correspondence in stereo views. The input is two or more images from multiple cameras. The method provides a map of links (disparity map), that maps every point from one image to a corresponding point in another image. The determined disparity will be large for short-distance objects, and will be small for far-distance objects. Thus, the disparity map could be treated as inverse of scene depth.

It is known in the related art that virtual views can be reconstructed from an image and a corresponding disparity/depth map using Depth-Image-Based-Rendering (DIBR) techniques, described in detail in an article, C. Fehn, “A 3D-TV Approach Using Depth-Image-Based Rendering (DIBR),” in Proc. of Visualization, Imaging, and Image Processing 2003, pp. 482-487, (Benalmadena, Spain), September 2003. However the camera parameters should be available for correct implementation of such methods, which are often not known when dealing only with captured visual content without any additional information.

However, the problem of a view generation can be solved by means of view interpolation and extrapolation, when the generated views are linear combination of input views. The appearance of “unfilled parts” in virtual views due to disocclusion could be compensated by filtration of neighboring pixels. The filtration may be effectively implemented using peculiarities of 3D scene geometry, when a disocclusion area will be filled by background colors, rather than foreground colors.

U.S. Patent Application Publication No. 2009/0129667 discloses a device and method for estimation of depth map, generation of intermediate image and encoding the multi-view video image. Estimation of disparity is carried out by two steps. First, a raw disparity estimate is computed and then a belief propagation (BP) method is applied for depth map enhancement. The BP methods output the best results for the task of disparity estimation but have drawbacks such as very high computational complexity and memory requirements. Thus, the BP methods are usually implemented as software applications for computers with off-line processing of multi-view data.

For generation of intermediate images, a related art visualization method based on using of image depth (depth image based rendering—DIBR) techniques, has been proposed in the article L. Zhang et al., “Stereoscopic Image Generation Based on Depth Images for 3D TV”, IEEE Trans. on Broadcasting, 2005, vol. 51, pp. 191-199. Here, for encoding the multi-view images, MPEG-like processing with block-based discrete cosine transformation (DCT) and subsequent entropy encoding was applied.

Russian Patent Application No. 2008144840 discloses a method of disparity estimation based on iterative filtration of a raw disparity estimate. The raw disparity estimate was computed by a known method based on local stereo-matching and then the filtration scheme was applied based on color information from a stereo-pair. To reduce the number of incorrect depth values, the principle of depth map gradient limit was applied. To reduce the computational burden, the adaptation of filter radius was investigated. For large number of iterations, e.g., greater than 6, the algorithm runs about 40% faster with enhanced quality outcomes.

Russian Patent Application No. 2008140111 discloses a method for fast enhancement of a raw disparity estimate. An aspect of the method is to find “bad pixels”, i.e., pixels which have erroneous depth data. These pixels are usually located in occlusion and low-textured areas of an image. After detection of such areas, correct depth map values are propagated into these areas by filtration according to image color. Only one color image is used in the method, which could output fine results of enhancement of raw disparity estimate, when the number of bad pixels in raw disparity map up-to 30%.

Russian Patent Application No. 2009110511 discloses a system for live 3D capturing and reproduction in an auto-stereoscopic display. The system includes an image capturing unit which grab images from stereo or multi-cameras, a disparity estimation unit which computes disparity between adjacent views, an a view synthesis unit which generates multiple views according to display requirements, to display 3D images. The corresponding methods of depth estimation and view synthesis are described in a manner to be suitable for execution on highly-parallel computational devices, such as a graphics processing unit (GPU) or a field-programmable array (FPGA).

WO 2005/101324 discloses a method for reduction of ghost artifacts during visualization of 2.5D graphics (an image with corresponding depth). The method creates an output image by transforming each input pixel to a transformed input pixel. Such transformation is a function of the input pixel depth. The output image is created, based on the transformed input pixels, using hidden image pixels for filling de-occluded areas and for at least one pixel position adjacent to the de-occluded areas. As a result, ghost line artifacts caused by transformation of the pre-filtered input image are prevented.

U.S. Patent Application Publication No. 2007/0052794 discloses a method for reducing eye-fatigue when watching 3D TV by adjustment of 3D content. The adjustment includes computation of block-based disparities between left-eye and right-eye images, and horizontal movement of left-eye and right-eye images using the estimated disparities. A horizontal movement value is computed as a result of filtration of all disparity vectors. In the simplest case, the average of all disparity vectors is used as the horizontal movement value.

U.S. Patent Application Publication No. 2007/0047040 discloses an apparatus and method for controlling the depth of a 3D image. The apparatus and method enable adaptively controlling the disparity to control the depth when a user uses a stereoscopic display having a different screen size than a display used in a manufacturing environment. This is achieved by a physical distance calculation between a left eye image and a right eye image based on a measured disparity and physical characteristics of a display with a subsequent depth adjustment based on the calculated physical distance.

U.S. Patent Application Publication No. 2008/0240549 discloses controlling dynamic depth of a stereo-view or multi-view sequence of images by estimation of disparity of corresponding stereo-view images with calculation of depth control parameters based on disparity histogram, and also by rearrangement of stereo-view images. Depth control parameters are determined through convolution of a disparity histogram with characteristic function. Two types of characteristic functions are disclosed: first characteristic function is designated for the scenes only with background information, and a second characteristic function is designated for the video with an evident foreground object and background. Based on a convolution sum of the characteristic function with the disparity histogram, the rearrangement amount of the stereo-view image is determined.

Visualization of an image based on interpolation using disparity map is problematic, especially for areas with sharp transitions by depth and with presence of occlusions, i.e., the closed areas. In 3D scenes, scene objects of the background may be blocked by objects of the foreground. At visualization of the image from a new foreshortening (position), earlier blocked parts of a scene become visible. This leads to occurrence of the unfilled parts due to disocclusion in the virtual image. Thus, a visualization method should provide compensation for such indefinite areas.

### SUMMARY

Exemplary embodiments provide a system and method of stereo-view and multi-view visualization for depth control in 3D TV-set, offering smooth control of depth perception during viewing a 3D TV signal.

According to an aspect of an exemplary embodiment, there is provided a method of stereo-view visualization for control of perception of depth of a stereoscopic image generated by display device, the method including: estimating a disparity map for a source stereo-view image; adjusting depth perception parameters adjustment of depth perception of observed 3D content in TV-set; generating a modified stereo-view image based on the source stereo-view image, the adjusted depth perception parameters and the estimated disparity map; and post-processing the modified stereo-view image by spatial filtering of disocclusions of the modified stereo-view image.

According to an aspect of an exemplary embodiment, there is provided a method of multi-view visualization for control of perception of depth of a stereoscopic image generated by display device, the method including: estimating a disparity map for a source stereo-view image; adjusting depth perception parameters; generating multi-view images based on the source stereo-view image, the estimated disparity map and the adjusted depth perception parameters; and post-processing the multi-view images by spatial filtering of disocclusions of the multi-view images.

According to an aspect of an exemplary embodiment, there is provided a system for stereo-view visualization for control of perception of depth of a stereoscopic image generated by display device, the system including: a disparity estimation unit that estimates a disparity map for a source stereo-view image; a depth control unit that adjusts depth perception parameters; a view renderer unit that receives the adjusted depth perception parameters, the disparity map and the source stereo-view image, generates a modified stereo-view image based on the source stereo-view image, the estimated disparity map and the adjusted depth perception parameters, and post-processes the modified stereo-view image by spatial filtering of disocclusions of the modified stereo-view image.

According to an aspect of an exemplary embodiment, there is provided a system for multi-view visualization for control of perception of depth of a stereoscopic image, generated by a display device, the system including: a disparity estimation unit that estimates a disparity map for a source stereo-view image; a depth control unit that adjusts depth perception parameters; a view renderer unit that receives the adjusted depth perception parameters, the estimated disparity map and the source stereo-view image, generates a multi-view image based on the source stereo-view image, the estimated disparity map and the adjusted depth perception parameters, and post-processes the multi-view image by spatial filtering of disocclusions of the multi-view image.

### BRIEF DESCRIPTION OF THE DRAWINGS

The above and other aspects will become more apparent by describing in detail exemplary embodiments with reference to the attached drawings in which:

FIG. 1 is a block diagram of an apparatus for stereo-view visualization for control of perception of depth of a stereoscopic image, generated by TV-set, according to an exemplary embodiment;

FIG. 2 is a block diagram of an apparatus for multi-view visualization for control of perception of depth of a 3D image generated by TV-set according to an exemplary embodiment;

FIG. 3 is a flowchart of a method of stereo-view visualization for control of perception of depth of a stereoscopic image generated by TV-set according to an exemplary embodiment;

FIG. 4 is a flowchart of a method of multi-view visualization for control of perception of depth of a 3D image generated by TV-set according to an exemplary embodiment;

FIGS. 5A and 5B are diagrams illustrating stereo-view generation;

FIGS. 6A, 6B and 6C are diagrams illustrating multi-view generation;

FIGS. 7A and 7B are diagrams illustrating disocclusion appearance in virtual view; and

FIG. 8 is a flowchart of a method of virtual view generation through disparity-based mapping according to an exemplary embodiment.

### DETAILED DESCRIPTION OF EXEMPLARY EMBODIMENTS

Hereinafter, exemplary embodiments will be described in detail with reference to the accompanying drawings. Expressions such as “at least one of,” when preceding a list of elements, modify the entire list of elements and do not modify the individual elements of the list. The term “unit” as used herein means a hardware component and/or a software component that is executed by a hardware component such as a processor.

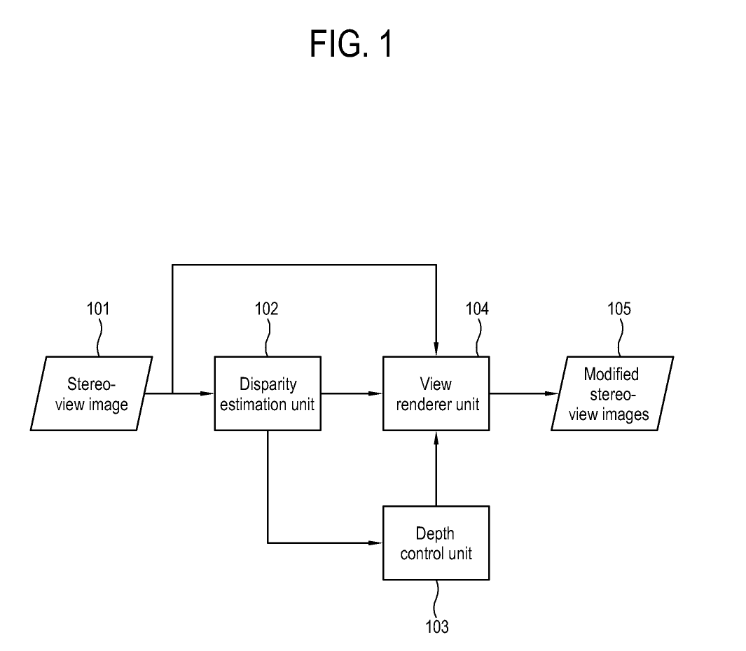

FIG. 1 is a block diagram illustrating a structure of an apparatus for stereo-view visualization for control of perception of depth of a stereoscopic image generated by TV-set, according to an exemplary embodiment. Referring to FIG. 1, the apparatus for stereo-view visualization includes a disparity estimation unit 102, a depth control unit 103, and a view renderer unit 104. The disparity estimation unit 102 estimates a disparity map from a stereo-view image 101. The initial disparity map can be generated by any known method of the related art. The taxonomy of methods of generating of the disparity map through stereo-matching operation are described in the publication D. Scharstein et al. “A taxonomy and Evaluation of Dense Two-Frame Stereo Correspondence Algorithms” (http://vision.middlebury.edu/stereo/taxonomy-IJCV.pdf). Examples of realization of computation of the disparity map by a digital signal processor (DSP) and a FPGA are disclosed in U.S. Pat. No. 5,179,441 (Anderson et al., “Near Real-Time Stereo Vision System”) and U.S. Pat. No. 7,194,126 (K. Konolige, “Realtime Stereo and Motion Analysis on Passive Video Images Using an Efficient Image-to-Image Comparison Algorithm Requirirbg Minimal Buffering”). The disparity map is used for generation of a modified stereo-view image 105 by the view renderer unit 104 in accordance with depth perception parameters provided by the depth control unit 103. The depth control unit 103 can be implemented, for example, by a microprocessor system with a memory. The view renderer unit 104 can be implement by a DSP or an FPGA, as the algorithm of a filtration of images for discrete numbers is used for generation of the modified stereo-view image 105.

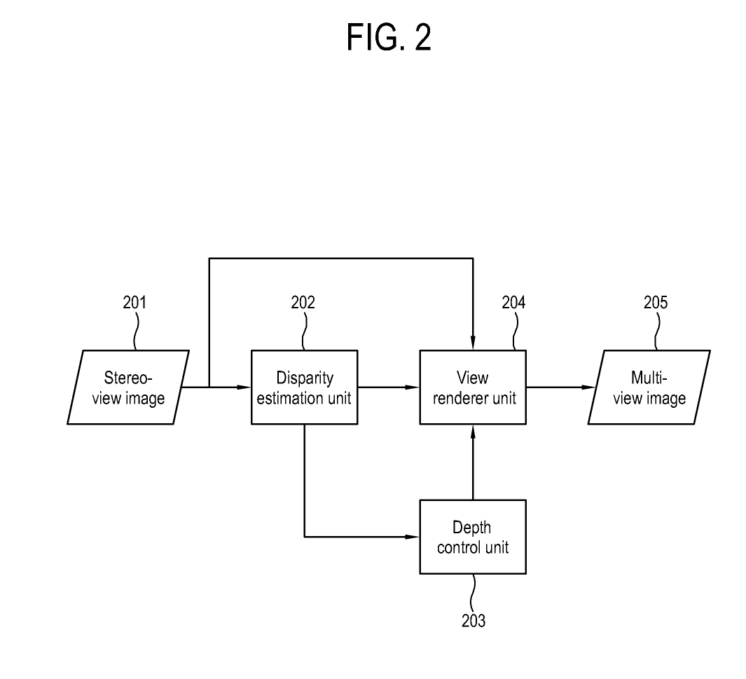

FIG. 2 is a block diagram illustrating a structure of an apparatus for multi-view visualization for control of perception of depth of a stereoscopic image generated by TV-set, according to an exemplary embodiment. The apparatus for multi-view visualization includes a disparity estimation unit 202, a depth control unit 203, and a view renderer unit 204. The disparity estimation unit 202 estimates a disparity map from a stereo-view image 201. The initial disparity map can be generated by any known method of the related art as discussed above with regard to the disparity estimation unit 102 of FIG. 1. The disparity map is required for generation of a multi-view image 205 by the view renderer unit 204 with accordance of depth perception parameters provided by the depth control unit 203. The depth control unit 203 may be implemented, for example, by a microprocessor system with a memory. In turn the view renderer unit 204 may be implemented, for example, by a DSP or an FPGA, as the method of a filtration of images for discrete numbers is used for generation of the multi-view image in sequence.

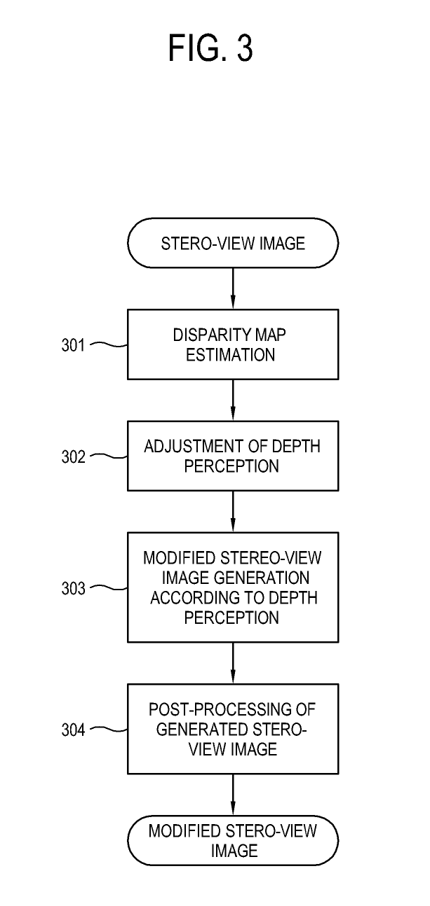

Referring to FIG. 3, a method for stereo-view visualization for control of perception of depth of stereoscopic image generated by TV-set will be described. In operation 301, disparity map estimation may be carried out using stereo-matching methods known in the related art. For example, the stereo-matching methods described in L. Zhang et al., “Stereoscopic Image Generation Based on Depth Images for 3D TV”, IEEE Trans. on Broadcasting, 2005, vol. 51, pp. 191-199, and Russian Patent Application No. 2008144840 may be used, but the inventive concept is not limited thereto and other methods may be used.

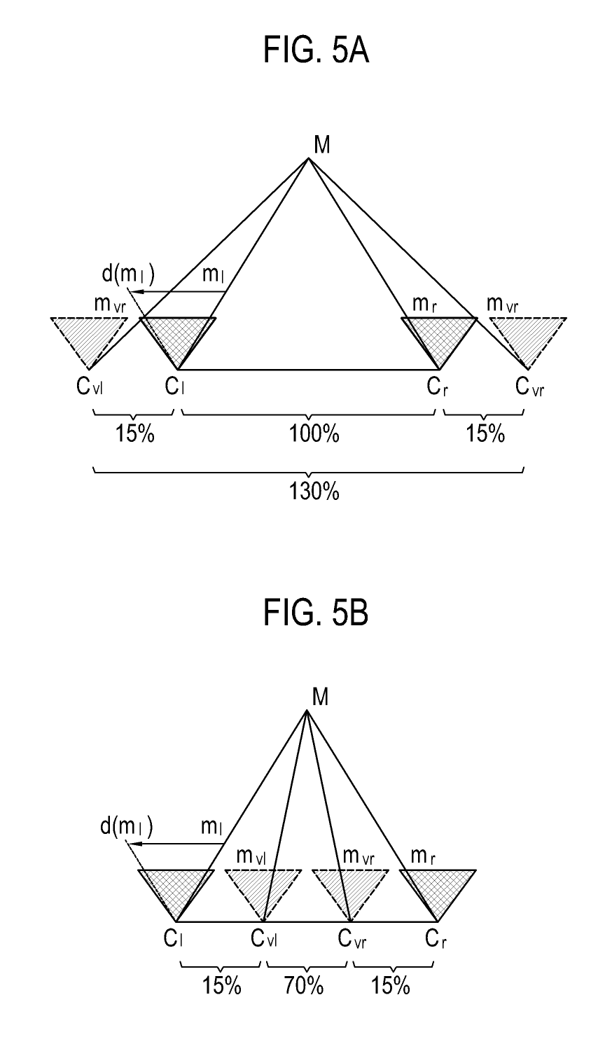

In operation 302, adjustment of depth perception of observed 3D content in TV is performed. This is done by changing spatial positions of left-eye and right-eye images. In the exemplary embodiment, depth perception is controlled by a parameter D, which changes from D_{inc} to D_{dec}. In the exemplary embodiment, D_{inc}=−0.5 and D_{dec}=0.5. The parameter D corresponds to the portion of disparity vector, used for view visualization. If D=0, it means the stereo-view does not change. If D<0, it means the stereo-images are shifted away from each other in an outward direction (see FIG. 5A). This leads to a depth perception increase while watching a modified stereo-view. Conversely, if left-eye and right-eye images are shifted within stereo-view toward each other (FIG. 5B), this will lead to a depth perception decrease. When the D=0.5 it is the case of monocular view, when the left-eye and right-eye images are coincident in the space. Thus, the parameter D should be less than 0.5.

According to the value of D, the modified left-eye and right-eye images are generated in operation 303, and then post-processing of the modified stereo-view image is performed in operation 304. The modified views may be synthesized by mapping a source image on a modified image, based on the disparity map, since the disparity map estimated in operation 301 provides pixel correspondences between initial left-eye and right-eye images. The disparity-based mapping may be implemented in left and right directions.

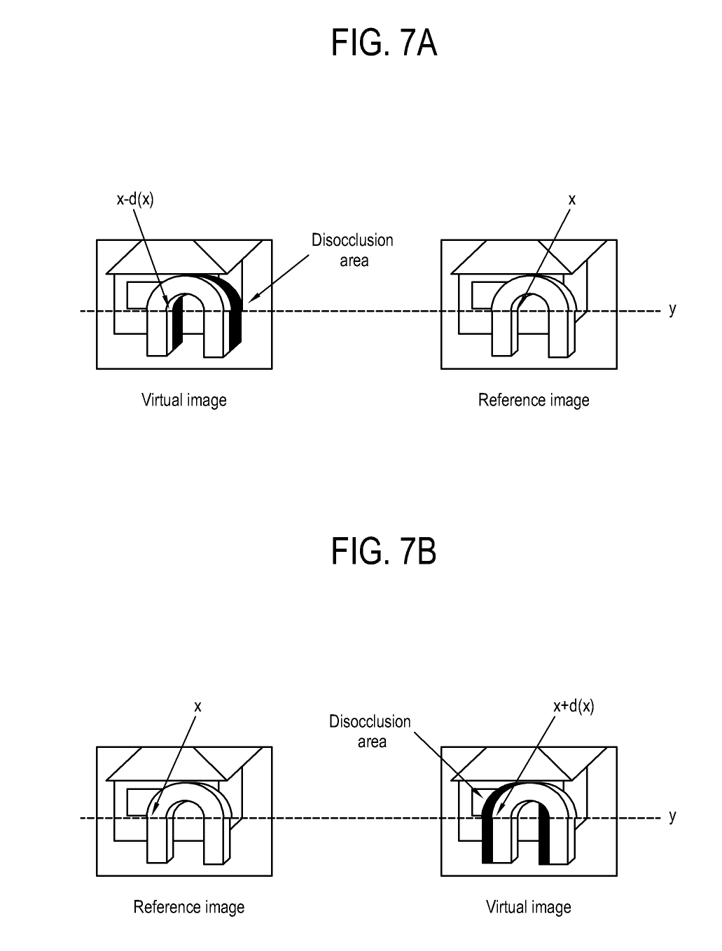

FIG. 7A illustrates disparity-based mapping when a virtual image is generated in a negative X-axis direction of a reference image. In this situation, disocclusion areas appear on the right side of the objects.

FIG. 7B illustrates disparity-based mapping, when the virtual image is generated in a positive X-axis direction of a reference image. In this situation, disocclusion areas appear on the left side of the objects. The disocclusion area is an area in a virtual image, which became visible in the virtual image and was occluded by foreground objects in a reference image. The disocclusion areas are filled by filtration of the disparity map, where the difference between previous and current disparity vectors is used as a padding size for disocclusion filtering of a current pixel in the virtual image.

For the case of amplification of depth perception, a virtual left-eye image should be generated on the right side of a reference left-eye image, and a virtual right-eye image should be generated on the left side of a reference right-eye image.

For the case of reduction of depth perception, a virtual left-eye image should be generated on the left side of a reference left-eye image, and a virtual right-eye image should be generated on the right side of a reference right-eye image.

For both cases of depth reduction and amplification, the virtual stereo-view is created by generation of a virtual left-eye image and a virtual right-eye image.

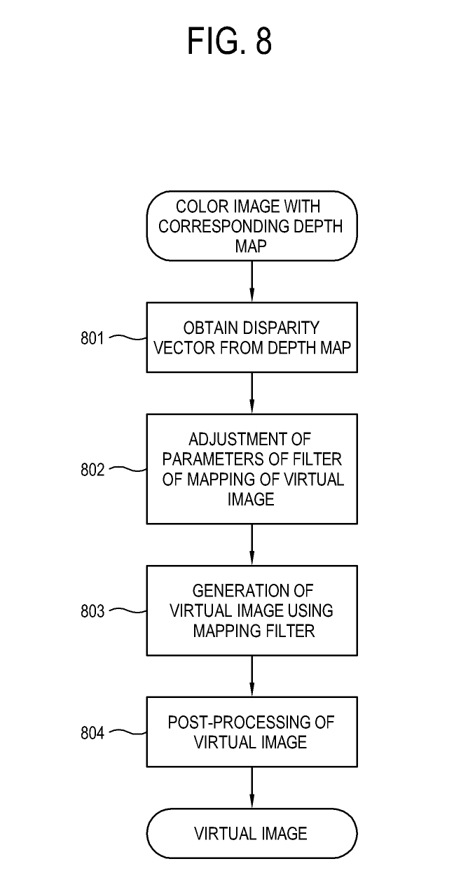

A method of virtual view generation trough disparity-based mapping is presented in FIG. 8. In operation 801, a disparity value is obtained from a disparity map. The method uses a left-to-right scan line order to obtain a disparity value for each image pixel. Adjacent disparity values are used for visualization. Dₚᵣ=d(x−1, y) is defined as disparity value for a pixel (x−1, y) from a disparity map d. D_{cr}=d(x, y) is defined as disparity value for a pixel (x, y) from the disparity map d.

After Dₚᵣ and D_{cr} have been fetched from disparity memory buffer, an estimation of parameters for a filter of mapping of a virtual image using the disparity map is performed. In the exemplary embodiment, the parameters for the filter of mapping of the virtual image based on the disparity map include a padding size Pₕ(x, y) of the filter. Padding size is the number of pixels in a horizontal direction to be filled with background pixels. The padding size is estimated as a difference of disparity values of a previous pixel and a current pixel in a scan order of a line of a reference color image. The padding size Pₕ(x, y) for a pixel (x, y) is estimated as:

$${P}_{h} ( x , y ) = \{ \begin{matrix}{D}_{pr} - {D}_{cr} , & if {D}_{pr} > {D}_{cr} \\ 0 , & otherwise ,\end{matrix}$$

where Dₚᵣ is disparity value for pixel (x−1, y), and D_{cr} is disparity value for pixel (x, y).

After the padding size of the mapping filter of the virtual image is determined, based on the disparity map, the virtual view in negative X-axis direction of a reference image in an RGB format is generated in operation 803 as follows:

$$v = S ( x , y ) , \\ ∀ v ∈ V = \{ ( \begin{matrix}R ( x - Δ x - {D}_{cr} , y ) , \\ G ( x - Δ x - {D}_{cr} , y ) , \\ B ( x - Δ x - {D}_{cr} , y )\end{matrix} ) \vert \begin{matrix}x ∈ Z ⋂ [ 0 , width ] \\ y ∈ Z ⋂ [ 0 , height ] \\ Δ x ∈ Z ⋂ [ 0 , {P}_{h} ( x , y ) ]\end{matrix} \} , \qquad ( 1 )$$

where v is a generated virtual image, S(x, y) is an RGB pixel from the reference image with a coordinate (x, y). The reference image is defined as an image for a left or right eye from a stereo-pair, which is used as a source for a disparity mapping operation, width is an image width, and height is an image height. The visualization process, i.e., generation of modified image, is illustrated in FIG. 7A. From FIG. 7A, it is visible that the center of the coordinate system of the reference image is located in the bottom left corner of the image.

If the virtual view should be rendered in positive X-axis direction of a reference image, it is generated as follows:

$$v = S ( x , y ) , \\ ∀ v ∈ V = \{ ( \begin{matrix}R ( x + Δ x + {D}_{cr} , y ) , \\ G ( x + Δ x + {D}_{cr} , y ) , \\ B ( x + Δ x + {D}_{cr} , y )\end{matrix} ) \vert \begin{matrix}x ∈ Z ⋂ [ 0 , width ] \\ y ∈ Z ⋂ [ 0 , height ] \\ Δ x ∈ Z ⋂ [ 0 , {P}_{h} ( x , y ) ]\end{matrix} \} , \qquad ( 2 )$$

where v is a generated virtual image, and a S(x, y) is an RGB pixel from the reference image with the coordinate (x, y). The visualization process is illustrated in FIG. 7B. In this case, the method uses a right-to-left scan line order to obtain a disparity value for each pixel of reference image. If a left-to right scan order is used, the virtual image will have overlapped parts from previously mapped pixels.

After visualization of a virtual image using the mapping filter, based on disparity, some disocclusion areas may have artifacts, where parts of an image (usually background) become visible in the virtual image. Thus, these parts of the image have been hidden by foreground objects in the reference image. For correction of values of pixels in such areas, the post-processing of virtual image is performed in operation 804. To mask out the disocclusion pixels from other image pixels, the binary mask m is created during view visualization. Initially, all values of a buffer m are set to zeros. According to the equations below, the pixels of the virtual image, which are mapped from the reference image, based on disparity map, are set to 1. If the virtual image should be rendered in a negative X-axis direction of the reference image, the mask is created as

$$m = E ( x , y ) , \\ ∀ m ∈ V = \{ I ( x - {D}_{cr} , y ) \vert \begin{matrix}x ∈ Z ⋂ [ 0 , width ] \\ y ∈ Z ⋂ [ 0 , height ]\end{matrix} \} . \qquad ( 3 )$$

If the virtual image should be rendered in a positive X-axis direction of the reference image, the mask is created as

$$m = E ( x , y ) , \\ ∀ m ∈ V = \{ I ( x + {D}_{cr} , y ) \vert \begin{matrix}x ∈ Z ⋂ [ 0 , width ] \\ y ∈ Z ⋂ [ 0 , height ]\end{matrix} \} , \qquad ( 4 )$$

where m is a binary mask, in which 0 means disocclusion area, and 1 means normal pixel area, E(x, y) is a pixel from a binary image I, in which all pixels are set to 1, D_{cr} is the disparity vector for a current pixel (x, y) of the disparity map d, width is an image width, and height is an image height.

After the mask m has been generated, the virtual view is generated by post-processing of the virtual image (Step 804). The post-processing includes spatial filtration for disocclusion areas, for which m=0 as follows:

$$I ( x , y ) = \{ \begin{matrix}SpatialFilter ( x , y ) , & if m ( x , y ) = 0 \\ I ( x , y ) & otherwise ,\end{matrix} \qquad ( 5 )$$

where SpatialFilter ( ) is a function for computation of a filtered value for RGB pixels in a neighborhood of a pixel (x, y), and I(x, y) is a virtual image pixel.

In the exemplary embodiment, the SpatialFilter ( ) method is realized using a Gaussian spatial filter. The Gaussian filter is well-known in the related art, and therefore the description thereof is omitted herein. However, embodiments are not limited thereto and any type of spatial filter can be used for intensity smoothing.

Generated left-eye and right-eye images form the modified stereo-view image, which has modified parallax in comparison with the original stereo-view image. The parallax could be increased or decreased. The modified stereo-view image with reduced parallax results in decreased eye fatigue when viewing 3D TV for long periods.

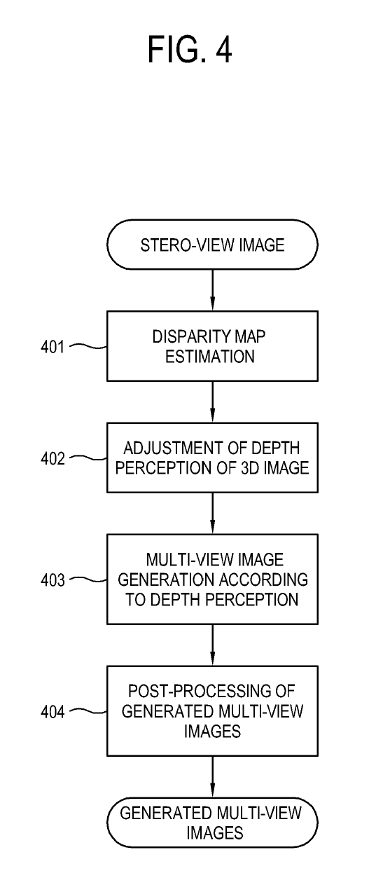

A method for multi-view visualization for control of perception of depth of a stereoscopic image generated by TV-set will be described with reference to (FIG. 4. In operation 401, disparity map estimation is performed. The disparity map estimation is carried out using known stereo-matching methods such as the related art methods discussed above. However, embodiments are limited thereto.

In operation 402, adjustment of depth perception of observed 3D content in the TV-set is performed by changing positions of a multi-view image sequence. Thus, the multi-view image is understood as a sequence of images, in which each adjacent pair of images forms the stereo-view image (stereo-pair).

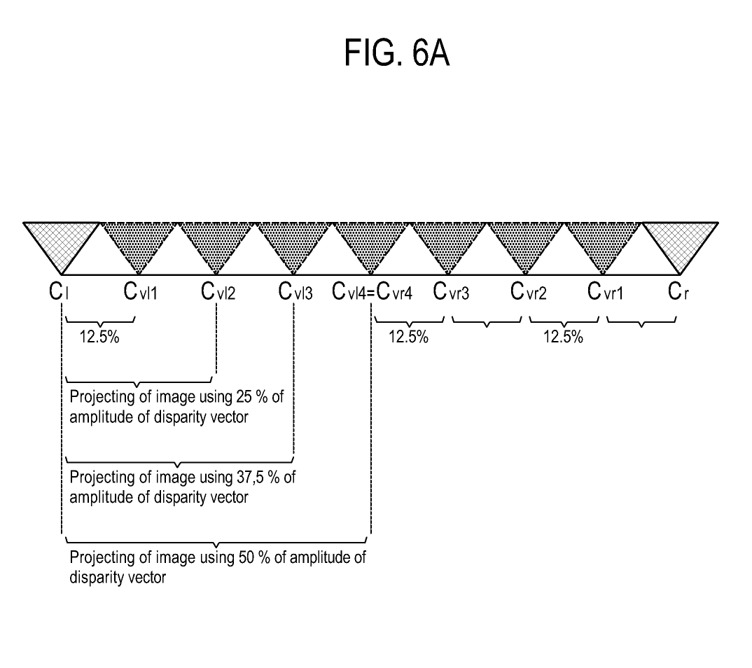

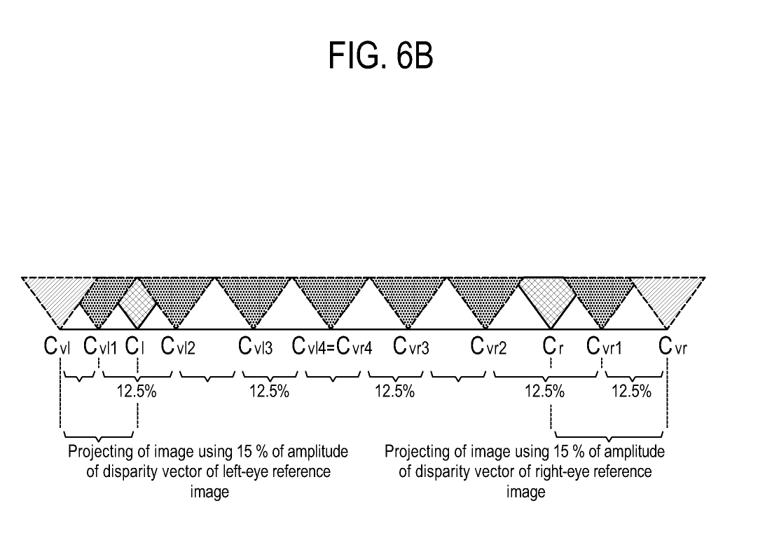

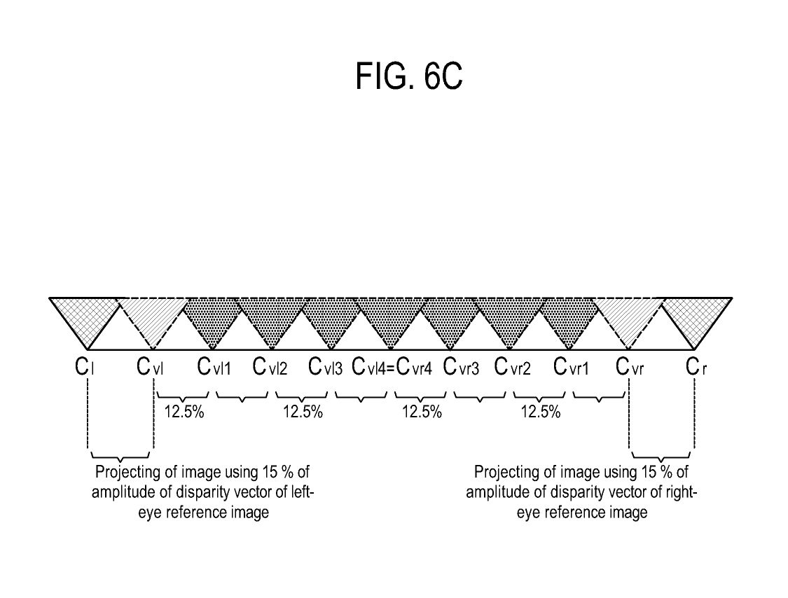

In the exemplary embodiment, depth perception is controlled by a parameter D, which changes from D_{inc} to D_{dec}. In the exemplary embodiment, D_{inc}=−0.5 and D_{dec}, =0.5. The parameter D corresponds to the portion of disparity vector, used for view visualization. If D=0, it means the multi-view image sequence is generated without alteration of depth perception (FIG. 6A). If D<0, it means the multi-view images are shifted away from each other in an outward direction (see FIG. 6B). This leads to an increase in depth perception while watching a modified multi-view image sequence. Conversely, if multi-view images are shifted toward each other (see FIG. 6C), this will lead to a decrease in depth perception.

According to the value of D, the modified multi-view image sequence is generated in operation 403 and the modified multi-view images are post-processed in operation 404. The modified views are expediently synthesized by a disparity-based mapping, since such disparity map calculated in operation 401 provides pixel correspondences between initial left-eye and right-eye images (depicted as triangles with solid lines in FIG. 6A, 6B, 6C). The multi-view visualization method first generates an outermost (the most distant from the middle) virtual left-eye view and an outermost virtual right-eye view in accordance with Equations (1) and (2). Generated virtual left-eye and right-eye views are depicted as triangles with dotted lines, in FIG. 6B and FIG. 6C. Then, the method compensates disocclusion areas of virtual views using Equations (3)-(5). Also, for outermost virtual images, the depth maps are generated using Equations (1)-(5).

After the outermost virtual images have been generated, central virtual images are generated according to Equations (1)-(5) using outermost virtual images with corresponding depth maps as source data. Central virtual images are depicted by triangles with dotted lines, in FIG. 6A, 6B, 6C.

The exemplary embodiments may be utilized in a hardware implementation of television signal processing and view visualization in 3D TV devices. Currently, a problem in 3D TV mass production is user complaints of eye fatigue. Eye fatigue may be suppressed by reduction of depth perception via virtual stereo-image generation.

Depth control function for eye fatigue reduction may be realized in two different cases. A first case is manual adjustment when a user has some controls and can switch the parameters according to the user's own preferences to make the user's eyes comfortable. A second case is usage of some kind of eye fatigue indication function, which automatically controls depth of displayed 3D content to make a user enjoy 3D TV without any discomfort. The depth control function is used after the depth estimation for preprocessing depth parameters before visualization of an adjusted stereo-view.

The systems and methods for image visualization according to the exemplary embodiments provide use of one line of memory for disparity values and one line of memory for samples of the image. At the same time, the filter for post-processing uses several lines of memory (for example, 3-5 lines) for de-occluded areas.

The exemplary embodiments can be implemented as computer programs stored in a computer readable recording medium and executed in general-use digital computers. Examples of the computer readable recording medium include magnetic storage media (e.g., ROM, floppy disks, hard disks, etc.) and optical recording media (e.g., CD-ROMs, or DVDs).

While exemplary embodiments have been particularly shown and described, it will be understood by those of ordinary skill in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description of the exemplary embodiments but by the appended claims, and all differences within the scope will be construed as being included in the inventive concept.

What is claimed is:

1. A method of stereo-view visualization for control of perception of depth of a stereoscopic image generated by display device, the method comprising:
estimating a disparity map for a source stereo-view image;
adjusting depth perception parameters adjustment of depth perception of observed 3D content in the display device
generating a modified stereo-view image based on the source stereo-view image, the adjusted depth perception parameters and the estimated disparity map; and
post-processing the modified stereo-view image by spatial filtering of disocclusions of the modified stereo-view image.

2. The method as claimed in claim 1, wherein the depth perception parameters are adjusted by to user control.

3. The method as claimed in claim 1, wherein a value D of a depth perception parameter varies from −0.5 to 0.5, an increase of stereoscopic parallax between images for a left eye and a right eye corresponds to when the value D is less than 0, and a decrease of stereoscopic parallax between images for the left eye and the right eye corresponds to when the value D is greater than 0.

4. The method as claimed in claim 1, wherein the modified stereo-view image is synthesized by visualization of a virtual image for a left eye from the source stereo-view image for the left eye and visualization of a virtual image for a right eye from the source stereo-view image for the right eye.

5. The method as claimed in claim 1, wherein the generating the modified stereo-view image comprises generating a virtual image for a left eye in a negative X-axis direction of a source stereo-view image for the left eye and generating a virtual image for a right eye in a positive X-axis direction of a source stereo-view image for the right eye, so that the modified stereo-view image has a stereoscopic parallax and a depth perception which are less than that of the source stereo-view image, and
wherein a center of coordinates of a coordinate system for the source stereo-view images for the left and right eyes is located in a bottom left corner of images.

6. The method as claimed in claim 1, wherein the generating the modified stereo-view image comprises generating a virtual image for a left eye in a positive X-axis direction of a source stereo-view image for the left eye and generating a virtual image for a right eye in a negative X-axis direction of a source stereo-view image for the right eye, so that the modified stereo-view image has a stereoscopic parallax and a depth perception which are greater than that of the source stereo-view image, and
wherein a center of coordinates of a coordinate system for the source stereo-view images for the left and right eyes is located in a bottom left corner of images.

7. The method as claimed in claim 6, wherein the virtual image is generated in a negative X-axis direction of a reference image using the filter of representation of virtual image based on disparity map as
$$v = S ( x , y ) , \\ ∀ v ∈ V = \{ ( \begin{matrix}R ( x - Δ x - {D}_{cr} , y ) , \\ G ( x - Δ x - {D}_{cr} , y ) , \\ B ( x - Δ x - {D}_{cr} , y )\end{matrix} ) \vert \begin{matrix}x ∈ Z ⋂ [ 0 , width ] \\ y ∈ Z ⋂ [ 0 , height ] \\ Δ x ∈ Z ⋂ [ 0 , {P}_{h} ( x , y ) ]\end{matrix} \} ,$$
where v is the generated virtual image, S(x, y) is an RGB pixel from a reference image with a coordinate (x, y), D_{cr} is a disparity value for a pixel (x, y) of the reference image, width is an image width, height is an image height, Pₕ (x, y) is a padding size of a filter for representation of the virtual image for a pixel of the reference image with the coordinate (x, y), and a center of coordinates of a coordinate system for the reference image is located in a bottom left corner of the reference image.

8. The method as claimed in claim 6, wherein the virtual image is generated in a positive X-axis direction of a reference image using the filter for representation of the virtual image based on the disparity map as
$$v = S ( x , y ) , \\ ∀ v ∈ V = \{ ( \begin{matrix}R ( x + Δ x + {D}_{cr} , y ) , \\ G ( x + Δ x + {D}_{cr} , y ) , \\ B ( x + Δ x + {D}_{cr} , y )\end{matrix} ) \vert \begin{matrix}x ∈ Z ⋂ [ 0 , width ] \\ y ∈ Z ⋂ [ 0 , height ] \\ Δ x ∈ Z ⋂ [ 0 , {P}_{h} ( x , y ) ]\end{matrix} \} ,$$
where v is the generated virtual image, S(x, y) is an RGB pixel from a reference image with a coordinate (x, y), D_{cr} is a disparity value for a pixel (x, y) of the reference image, width is an image width, height is an image height, Pₕ (x, y) is a padding size of a filter for representation of the virtual image for the pixel of reference image with the coordinate (x, y), and a center of coordinates of a coordinate system for the reference image is located in a bottom left corner of the reference image.

9. The method claimed as claim 8, wherein the padding size Pₕ (x, y) of the filter for representation of the virtual image for the pixel (x, y) is determined as
$${P}_{h} ( x , y ) = \{ \begin{matrix}{D}_{pr} - {D}_{cr} , & if {D}_{pr} > {D}_{cr} \\ 0 , & otherwise\end{matrix}$$
where Dₚᵣ is a disparity value for pixel (x−1, y); and
D_{cr} is a disparity value for pixel (x, y).

10. The method as claimed in claim 6, wherein if the virtual image is to be rendered in the negative X-axis direction of the reference image, a mask for the filtering of the disocclusions is created as
$$m = E ( x , y ) , \\ ∀ m ∈ V = \{ I ( x - {D}_{cr} , y ) \vert \begin{matrix}x ∈ Z ⋂ [ 0 , width ] \\ y ∈ Z ⋂ [ 0 , height ]\end{matrix} \} ,$$
where m is a binary mask, in which 0 means a disocclusion area, and 1 means a normal pixel area,
E(x, y) is a pixel from a binary image I, in which all pixels are set to 1,
D_{cr} is a disparity vector for a current pixel (x, y) of the disparity map d,
width is an image width, and height is an image height, and a center of coordinates of a coordinate system for a reference image is located in a bottom left corner of the reference image.

11. The method as claimed in claim 6, wherein if the virtual image is to be rendered in the positive direction of axis X of the reference image, a mask for the filtering of the disocclusions is created as
$$m = E ( x , y ) , \\ ∀ m ∈ V = \{ I ( x + {D}_{cr} , y ) \vert \begin{matrix}x ∈ Z ⋂ [ 0 , width ] \\ y ∈ Z ⋂ [ 0 , height ]\end{matrix} \} ,$$
where m is a binary mask, in which 0 means a disocclusion area, and 1 means a normal pixel area,
E(x, y) is a pixel from a binary image I, in which all pixels are set to 1,
D_{cr} is a disparity vector for a current pixel (x, y) of the disparity map d,
width is an image width, and height is an image height, and a center of coordinates of a coordinate system for a reference image is located in a bottom left corner of the reference image.

12. The method as claimed in claim 1, wherein the post-processing includes filtering disocclusion areas, for which a binary mask m=0
$$I ( x , y ) = \{ \begin{matrix}SpatialFilter ( x , y ) , & if m ( x , y ) = 0 \\ I ( x , y ) & otherwise ,\end{matrix}$$
where SpatialFilter ( ) is a function for computation of a filtered value for RGB pixels in a neighborhood of a pixel (x, y), and
I(x, y) is a virtual image pixel.

13. The method as claimed in claim 12, wherein a Gaussian filter is used for the filtering.

14. A method of multi-view visualization for control of perception of depth of a stereoscopic image generated by display device, the method comprising:
estimating a disparity map for a source stereo-view image;
adjusting depth perception parameters;
generating multi-view images based on the source stereo-view image, the estimated disparity map and the adjusted depth perception parameters; and
post-processing the multi-view images by spatial filtering of disocclusions of the multi-view images.
